(19) United States
(12) Patent Application Publication
(10) Pub. No.: US 2010/0203442 A1
(43) Pub. Date: Aug. 12, 2010

(54) MANUFACTURING METHOD OF MAGENTA TONER FOR DEVELOPING ELECTROSTATIC IMAGE AND TONER

(75) Inventors: Ken OHMURA, Tokyo (JP); Hiroshi YAMAZAKI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/698,695

(22) Filed: Feb. 2, 2010

(30) Foreign Application Priority Data
Feb. 9, 2009 (JP) 2009027139

(51) Int. Cl. G03G 9/09; G03G 9/08; G03G 9/087

(52) U.S. Cl. 430/110.1; 430/137.15; 430/137.14; 430/105

(57) ABSTRACT

Disclosed is a manufacturing method of a magenta toner including the steps of dispersing an oil phase containing a radical polymerizable monomer for forming the binder resin and the colorant in an aqueous medium to form dispersion liquid in which the oil phase is dispersed in a form of droplets in the aqueous medium, and polymerizing the radical polymerizable monomer in the droplets in dispersion liquid to form resin particles containing colorant, in which the colorant comprises C.I. Solvent Red 48.

This application is based on Japanese Patent Application No. 2009-27139 filed on Feb. 9, 2009, in Japanese Patent Office, the entire content of which is hereby incorporated by reference.

### TECHNICAL FIELD

The present invention relates to manufacturing method of a toner for developing an electrostatic image and a toner manufactured by the method.

### BACKGROUND

A full color image can be formed by an electrophotographic process image forming method employing a toner for developing an electrostatic image (referred also as “a toner” shortly hereafter) in addition to a monochrome image conventionally used for document preparation, recently. Such a full color image forming method using a toner has been utilized in light printing field in which small amount of prints are mainly produced because it does not require printing plates and required amounts are prepared on demand. (See, for example, Patent Document 1).

The toner is required to have high color reproduction property to form an image reproducing color with high fidelity to the original in case that the full color printed matter such as catalogues or advertising material in particular. Target color is reproduced by secondary colors formed by a yellow toner, a magenta toner and/or a cyan toner in principle, in case of forming a full color image. Therefore, a toner of each base color is required to have high color reproduction property to realize color reproduction with high fidelity to the original. Various colorants are studied for a purpose of improving color reproduction property of toners in each color for this purpose.

For example, quinacridone pigment is listed for a magenta colorant for a color toner. A toner using the quinacridone pigment is used generally because it can form an image having excellent light fastness and magenta hue color. However, it is difficult to reproduce an image with high chroma on a display sufficiently because the quinacridone pigment has low dispersion property in resin, and is liable to form color turbid in the formed image.

In these circumstances, a toner to which a dye is added to improve chroma is disclosed (for example, see Patent Document 2), in place that a quinacridone pigment is used singly. Further a toner using a quinacridone pigment and a naphthol pigment in combination (see for example, Patent Document 3), or a toner using a quinacridone pigment and an anthraquinone pigment in combination (See, for example, Patent Document 4) are disclosed. However, these toners are inferior in light fastness of the obtained image and having problem not to maintain color hue for long term stably to a toner using quinacridone pigment singly.

### PRIOR ART

### Patent Documents

| | |
|---|---|
| Patent Document 1: | JP-A 2005-157314 |
| Patent Document 2: | JP-A 2007-286148 |
| Patent Document 3: | JP-A 2006-267741 |
| Patent Document 4: | JP-A 2006-154363 |

### SUMMARY

The present inventors have found that an image having bright color tone without color turbid can be formed when C.I. Solvent Red 48 is used as a magenta colorant as a result of studying magenta colorants. It has been also discovered that Solvent Red 48 is not dispersed with uniformity in a toner binder resin when a toner using the C.I. Solvent Red 48 is manufactured by kneading method. The reason is not clear but is assumed that the C.I. Solvent Red 48 is melted by a heat due to kneading process because it has dye structure, and difference of melt viscosity is large between the C.I. Solvent Red 48 and the binder resin.

The present invention was practiced in these circumstances, and a purpose of this invention is to provide a manufacturing method of a toner for developing an electrostatic image using C.I. Solvent Red 48 wherein the toner forms a color image having bright color tone without color turbid and excellent light fastness, as well as the toner for developing an electrostatic image.

The toner for developing an electrostatic image according to the present invention is composed of toner particles comprising colored particles containing a binder resin and a colorant. The colored particles are manufactured by a method comprising steps of; dispersing oil phase containing a radical polymerizable monomer which forms a binder resin and a colorant in an aqueous medium to prepare dispersion liquid, and polymerizing the radical polymerizable monomer in the dispersion liquid to form the colored particles, wherein the colorant comprises C.I. Solvent Red 48.

In other aspect of the present invention the magenta toner comprising colored particles containing at least a binder resin and a colorant, and the method comprises the steps of;

dispersing an oil phase containing a radical polymerizable monomer for forming the binder resin and the colorant in an aqueous medium to form dispersion liquid in which the oil phase is dispersed in a form of droplets in the aqueous medium, and

polymerizing the radical polymerizable monomer in the droplets in dispersion liquid to form resin particles containing colorant,

wherein the colorant comprises C.I. Solvent Red 48.

A volume based median diameter of the droplets is preferably 50 to 500 nm in one the embodiment.

A volume based median diameter of the resin particles is preferably 50 to 500 nm.

The method may further comprise the step of associating and fusing the resin particles containing colorant to form the colored particles.

A volume based median diameter of the colored particles is 3 to 10 μm in the other embodiment.

The method preferably comprises the steps of separating the colored particles from the liquid, and rinsing and drying the separated colored particles.

The colored particles each have preferably a core shell structure in the other embodiment.

The core and/or shell are preferably composed of the resin particles manufactured by a process described above.

The volume based median diameter of the core shell particles is 3 to 10 μm.

In one of the other embodiment a volume based median diameter of the droplets is preferably 3 to 10 μm.

In this instance a volume based median diameter of the colored particles is preferably 3 to 10 μm.

The method further comprises steps of separating the colored particles from the liquid, and rinsing and drying the separated colored particles.

The manufacturing method may further comprise steps of adding an additive to the separated colored particles after drying.

It is preferable that, in one of the embodiment of this invention, the oil phase is made droplets having particle size of volume based median diameter of 3 to 10 μm in dispersion liquid for obtaining colored particles composing toner particles in the polymerization process to form colored particles in one step.

Further the oil phase is made droplets having particle size of volume based median diameter of 50 to 500 nm in the dispersion liquid for obtaining colored particles, and the colored particles composing toner particles are prepared from particles formed in the polymerization step by an association step in which the particles are subjected to association and fusion process in aqueous medium in another embodiment of this invention.

In the image forming method of this invention is an image forming method employing full color toner kit composed of at least four color toners of a yellow toner comprising a binder resin and yellow colorant, a magenta toner comprising a binder resin and magenta colorant, a cyan toner comprising a binder resin and cyan colorant, and a black toner comprising a binder resin and black colorant, wherein the colored particles are manufactured by a method comprising steps of; dispersing oil phase containing a radical polymerizable monomer which forms a binder resin and a colorant in a aqueous medium to prepare dispersion liquid, and polymerizing the radical polymerizable monomer in the dispersion liquid to form the colored particles, and the colorant comprises C.I. Solvent Red 48.

It is preferable that the oil phase is made droplets having particle size of volume based median diameter of 3 to 10 μm in dispersion liquid for obtaining colored particles composing toner particles in the polymerization process to form colored particles in one step.

The oil phase may be made droplets having particle size of volume based median diameter of 50 to 500 nm in the dispersion liquid for obtaining colored particles, and the colored particles composing toner particles are prepared from particles formed in the polymerization step by an association step in which the particles are subjected to association and fusion process in aqueous medium.

While the colorant C.I. Solvent Red 48 is employed in toner particles composing a toner for developing an electrostatic image in this invention, oil phase containing a radical polymerizable monomer which forms a binder resin and a colorant is dispersed in an aqueous medium, and the radical polymerizable monomer in the dispersion liquid is polymerized to form the colored particles, whereby high dispersion state of C.I. Solvent Red 48 in the binder resin is realized, consequently, a color image having bright color tone without color turbid and excellent light fastness, as well as the toner for developing an electrostatic image.

Further according to the image forming method of the present invention C.I. Solvent Red 48 is employed as a magenta colorant contained in magenta toner particles composed of the magenta toner in the image forming method employing full color toner kit composed of at least four color toners. And the magenta toner particles are composed of colored particles obtained by dispersing oil phase containing a radical polymerizable monomer which forms a binder resin and a colorant in an aqueous medium to prepare dispersion liquid, and polymerizing the radical polymerizable monomer in the dispersion liquid to form the colored particles. Therefore, an image of primary color formed by the magenta toner for developing an electrostatic image has bright color tone without color turbid, and further, the secondary color formed by superposing other color toners on the magenta toner has bright color tone and high chroma color image can be formed.

### BRIEF DESCRIPTION OF DRAWING

FIG. 1: a schematic view of an example of an image forming apparatus used in the present invention.

### DESCRIPTION OF THE PREFERRED EMBODIMENT

### Toner for Developing Electrostatic Image

A toner for developing electrostatic image of the present invention is composed of colored particles obtained by processes comprising specific steps, and colorant comprises C.I. Solvent Red 48. The toner is used as a magenta toner to form a toner image of magenta color (later, abbreviated as “a magenta toner”).

### Colorant

The colorant composing toner particles contains C.I. Solvent Red 48. The colorant C.I. Solvent Red 48 is a quinacridone pigment having excellent transparency and high light fastness.

Wide color gamut can be reproduced and an image having stable color reproduction property by employing colorant containing C.I. Solvent Red 48 in the present invention. Particularly, an image having color gamut closed to one on the display of computer graphics having wide color gamut.

Content ratio of C.I. Solvent Red 48 is preferably 1 to 10% by weight based on the total amount of the toner, more preferably 2 to 8% by weight, to realize sufficient coloring power and good developability or chargeability.

Naphthol type pigments can be used in combination with C.I. Solvent Red 48 when the toner is used as a magenta toner. The content ratio of the type naphthol pigments is preferably less than 50% by weight based on the amount of C.I. Solvent Red 48 in this instance, to avoid occurrence of color turbid on the formed color image.

Examples of naphthol type pigments include, practically, C.I. pigment red 112, C.I. pigment red 146, Permanent Carmine FBB02 and C.I. pigment red 170.

It is preferable that C.I. Solvent Red 48 is dispersed in toner particles with number average primary particle diameter of 10 to 300 nm.

The number average primary particle diameter can be calculated by measuring FERRE direction diameter of the colorant employing 50,000 times magnified photography of cross section of toner particles by a transmission electron microscope, and an arithmetic average of diameter of the ten toner particles.

### Manufacturing Method of Toner

A polymerization method such as an emulsion polymerization method or suspension polymerization method can be applied to manufacture the toner of this invention, in which polymerizable monomer is polymerized whereby particles are formed with controlling the shape and size.

The manufacturing method includes, dispersion step of obtaining dispersion liquid by dispersing oil phase containing a radical polymerizable monomer to form a binder resin and the colorant in aqueous medium to obtain colored particles composing toner particles, polymerization step of polymerizing the radical polymerizable monomer in the dispersion liquid to form particles, and if necessary, association step of association and fusion of the particles formed in the polymerization step in aqueous medium.

In an example of a toner production by a suspension polymerization method, various kinds of constituent material such as a coloring agent, and wax, a charge controlling agent as occasion demands, and further an oil soluble polymerization initiator are added, in a polymerizable monomer, and the various kinds of constituent material are dissolved or dispersed in the polymerizable monomer by means of a homogenizer, a sand mill, a sand grinder, or an ultrasonic dispersion device. The polymerizable monomer having these various kinds of constituent material dissolved or dispersed is dispersed in an aqueous medium containing a dispersion stabilizer by the use of a homomixer or a homogenizer to become oil drops having a desired size as a toner. After that, it is moved to a reaction apparatus, is separated from liquid by filtration, washed, and further dried to become a toner of this invention prepared.

It is preferable that oil phase containing at least a radical polymerizable monomer and colorant is dispersed into oil droplets having volume based median diameter of 3 to 10 μm in the manufacturing method, whereby colorant (C.I. Solvent Red 48) is highly dispersed in a binder resin. An image having bright color tone can be formed by using the toner composed of the toner particles.

The volume-based median particle diameter is measured and calculated using a device constituted of “Coulter Multisizer III” (produced by Beckman Coulter, Inc.) and a data processing computer system (produced by Beckman Coulter, Inc.) connected thereto.

An example of a manufacturing method of a toner by an emulsion polymerization method is described. A colorant is incorporated in a polymerizable monomer, oil phase containing a colorant is dispersed into particles in an aqueous phase containing a surfactant via a mechanical energy, and particles are manufactured by polymerization reaction in a step of manufacturing resin particles. The particles are subjected to association and fusion with, if necessary, other component particles in aqueous medium, and the toner is obtained by filtration, rinsing and drying.

The particles obtained by the polymerization reaction is dispersed to have a number average primary particle diameter of 50 to 500 nm, and then the particle formed in the polymerization step may be subjected to association and fusion process in the toner manufacturing method. When oil phase is dispersed to oil droplets having number average primary particle diameter described above, and the droplets are subjected to association process, colorant composing toner particles (C.I. Solvent Red 48) is highly dispersed in a binder resin, and an image having bright color tone can be formed by using the toner particles.

The number average primary particle diameter is measured by a cataphoresis light scattering photometer “ELS-800” (product by Otsuka Electronics Co., Ltd.).

The term of “toner particles composing a toner” means that particles of colored particles to which an additive is added in case that later mentioned external additive is employed, and the colored particles as themselves in case that no external additive is used, in the present invention.

Herein, the “aqueous medium” refers to a medium containing water at a content ratio of at least 50% by weight. As a component other than water, a water-soluble organic solvent is utilized, including, for example, methanol, ethanol, isopropanol, butanol, acetone, methyl ethyl ketone, dimethylformamide, methyl cellosolve, and tetrahydrofuran. Of these, there is preferably utilized an alcohol based organic solvent such as methanol, ethanol, isopropanol or butanol which dissolves no resin.

As the binding resin for constituting the toner of the particles, following radical polymerizable monomers may be used. Polymers prepared by polymerization of a plural number of monomers in combination may be used for the polymer constituting the binder resin.

Examples of the vinyl type polymerizable monomer include those described below.

### (1) Styrene and its Derivatives

Styrene, o-methylstyrene, m-methylstyrene, p-methylstyrene, α-methylstyrene, p-chlorostyrene, 3.4-dichlorostyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene and p-n-dodecylstyrene;

### (2) Methacrylate Derivatives

Methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate;

### (3) Acrylate Derivatives

Methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate and phenyl acrylate;

### (4) Olefins

Ethylene, propylene and isobutylene;

### (5) Vinyl Esters

Vinyl propionate, vinyl acetate and vinyl benzoate;

### (6) Vinyl Ethers

Vinyl methyl ether and vinyl ethyl ether;

### (7) Vinyl Ketones

Vinyl methyl ketone, vinyl ethyl ketone and vinyl hexyl ketone;

### (8) N-Vinyl Compounds

N-vinylcarbazole, N-vinylindole and N-vinylpyrrolidone; and

### (9) Others

Vinyl compounds such as vinylnaphthalene and vinylpyridine, acrylic or methacrylic derivatives such as acrylonitrile, methacrylonitrile, and acrylamide.

As for polymerizable vinyl monomers, which constitute the resin, those having ionic dissociating groups, such as a carboxyl group, a sulfonic acid group, and a phosphoric acid group may be employed.

Examples having carboxylic acid include acrylic acid, methacrylic acid, maleic acid, itaconic acid, cinnamic acid, fumaric acid, maleic acid monoalkyl ester and itaconic acid monoalkyl ester. Examples having sulfonic acid include styrenesulfonic acid, allylsulfosuccinic acid, 2-acrylamido-2-methylpropanesulfonic acid, and examples having phosphonic acid include acid phosphoxyethyl methacrylate.

Further, it is possible to prepare resins having a cross-linking structure, employing polyfunctional vinyls such as divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol methacrylate, and neopentyl glycol diacrylate.

Toner particles may contain wax in the present invention. Waxes usable in the toner of the invention are those known in the art. Examples thereof include

(1) polyolefin wax such as polyethylene wax,
(2) polypropylene wax; long chain hydrocarbon wax such as paraffin wax and Sasol wax;
(3) dialkylketone type wax such as distearylketone;
(4) ester type wax such as carnauba wax, montan wax, trimethylolpropane tribehenate, pentaerythritol tetramyristate, pentaerythritol tetrabehenate, pentaerythritol diacetate dibehenate, glycerin tribehenate, 1,18-octadecanediol distearate, trimellitic acid tristearate, and distearyl maleate; and
(5) amide type wax such as ethylenediamine dibehenylamide and trimellitic acid tristearylamide.

The melting point of wax is usually in the range of 40 to 125° C., preferably 50 to 120° C. and more preferably 60 to 90° C. A melting point falling within the foregoing range can keep heat storage stability of the toner and perform stable image formation without causing offsetting even when fixed at a relatively low temperature. The wax content of the toner is preferably in the range of 1% to 30% by weight, and more preferably 5% to 20%.

A UV ray absorber may be incorporated in the toner to improve durability. The “UV ray absorber” is one absorbing electromagnetic wave having wave length of about 400 nm or shorter, so called UV ray, irradiated from sun beam or so. Practical examples of the UV ray absorbers include the following conventional compound.

Benzophenone type compound such as 2,4-dihydroxybenzophenone, 2-hydroxy-4-methoxy benzophenone, and 2-hydroxy-4-n-octyloxybenzophenone;

benzotriazole type compound such as 2-(2′-hydroxy-5′-t-butylphenyl)benzotriazole, 2-(2′-hydroxy-5′-methylphenyl)benzotriazole, 2-(2′-hydroxy-5′-t-octylphenyl)benzotriazole, 2-(3′-t-butyl2′-hydroxy-5′-methylphenyl-5-chlorobenzotriazole, 2-(3′,′-di-t-buty1-2′-hydroxy-5′-methylphenyl)-5-chlorobenzotriazole, and 2-(2′-hydroxy-3′,′-di(1,1-dimethylbenzyl)phenyl)-2H-benzotriazole;

hindered amine type compound such as bis(2,2,6,6-tetramethyl4-piperidyl)sebacate, and bis(1,2,2,6,6-pentamethyl4-piperidinyl)sebacate; and

benzoate type compound such as 2,4-di-t-butylphenyl3,5-di-t-butyl4-hydroxybenzoate.

Ratio of content of the UV ray absorber is 1 to 10% by weight with respect to a colorant.

The core shell toner is one of the preferable embodiments of the present invention. The core shell toner is prepared, for example, via the following processes:

(1) a dissolution/dispersion process in which releasing agents are dissolved in or dispersed into radically polymerizable monomers,
(2) a polymerization process in which a dispersion of fine resin particles is prepared,
(3) an association·fusion process in which core particles (being associated particles) are obtained by aggregating and fusing the fine resin particles and colorant particles in an aqueous medium,
(4) a first ripening process in which the form of the associated particles is controlled by ripening employing thermal energy,
(5) a shell formation process in which colored particles, having a core-shell structure, are formed by adding shell resin particles into the core particle dispersion and by allowing the shell resin particles to aggregate and fuse onto the surfaces of the core particles,
(6) A second ripening process in which the form of the colored particles having a core-shell structure is controlled by ripening the colored particles having the core-shell structure employing thermal energy,
(7) A washing process in which the colored particles are subjected to solid-liquid separation from the cooled colored particle dispersion and surfactants are removed from the colored particles, and
(8) A drying process in which the washed colored particles are dried.

Further a process of adding an external additive may be optionally employed.

Initially, when producing the toner of the present invention, core particles are produced via an association·fusion process applied to fine resin particles and colorant particles. Subsequently, shell resin particles are added to core particle dispersion, and the surface of the core particles is coated with the shell resin particles by aggregating and fusing the latter to prepare the colored particles having a core-shell structure. In this way, a toner having a core-shell structure is prepared by fusing core particles to resin particles, in which the resin particles are added to the core particle dispersion, which has been prepared via appropriate production methods.

### Polymerization Initiator

Examples of the aforesaid water soluble polymerization initiator include: a persulfate salt such as potassium persulfate or ammonium persulfate; azobisaminodipropane acetic acid salts; azobiscyanovaleric acid and salts thereof; and hydrogen peroxide.

Examples of the aforesaid oil soluble polymerization initiator include:

(a) azo based or diazo based polymerization initiators; 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile,
(b) peroxide based polymerization initiators; benzoyl peroxide, methyl ethyl ketone peroxide, diisopropylperoxy carbonate, cumenehydroperoxide, t-butylhydroperoxide, di-t-butyl peroxide, dicumyl peroxide, 2,4-dichlorobenzoyl peroxide, lauroyl peroxide, 2,2-bis-(4,4-t-butylperoxycyclohexyl)propane, and tris-(t-butylperoxy)triazine, and
(c) polymer polymerization initiators having a peroxide on the side chain.

### Chain Transfer Agent

In this polymerization step, conventionally used chain transfer agents can be employed in order to regulate the molecular weight of the targeted core forming binder resin. A chain transfer agent used for the present invention is not specifically limited. Examples of a chain transfer agent include: a mercaptan such as n-octylmercaptan, n-decylmercaptan, or tert-dodecylmercaptan; a mercaptopropionic acid ester such as n-octyl-3-mercaptopropionic acid ester; terpinolene; and α-methylstyrene dimer.

A salting-out/fusion method, being a preferred association and fusion method, is performed as follows: a salting-out agent, composed of an alkali metal salt, an alkaline earth metal salt, or a trivalent salt, serving as an aggregating agent at a concentration being at least its critical association concentration, is added to water containing fine resin particles and colorant particles, followed by conducting fusion and salting-out concurrently via heating up to at least the glass transition point of the fine resin particles, as well as up to the melting peak temperature (° C.) of the mixture. Herein, examples of the alkali metal salt and the alkaline earth metal salt as a salting-out agent include lithium, potassium, and sodium as the alkali metal salt, and magnesium, calcium, strontium, and barium as the alkaline earth metal salt. Of these, potassium, sodium, magnesium, calcium, and barium are preferred.

The toner may be incorporated with an external additive such as particles of organic microparticles or organic microparticles having number average primary particle diameter of 4 to 800 nm. Addition of the external additive improves fluidity or charging property and realizes improvement of cleaning property of the toner.

Inorganic microparticles may be employed. Specifically, it is possible to preferably employ minute silica, titanium, and alumina particles and the like. These minute inorganic particles subjected to hydrophobic processing may be used.

Specifically listed as silica microparticles, for example, are commercially available R-805, R-976, R-974, R-972, R-812, and R-809, produced by Nippon Aerosil Co. Ltd.; HVK-2150 and H-200, produced by Hoechst AG; commercially available TS-720, TS-530, TS-610, H-5, and MS-5, produced by Cabot Corp; and the like.

Listed as titanium microparticles, for example, are commercially available T-805 and T-604, produced by Nippon Aerosil Co.; commercially available MT-100S, MT-100B, MT-500BS, MT-600, MT-600SS and KA-1, produced by TAYCA CORPORATION; commercially available TA-300SI, TA-500, TAF-130, TAF-510 and TAF-510T, produced by Fuji Titanium Industry Co., Ltd.; commercially available IT-S, IT-OA, IT-OB and IT-OC, produced by Idemitsu Kosan Co.; and the like.

Listed as alumina microparticles, for example, are commercially available RFY—C and C-604, produced by Nippon Aerosil Co., commercially available TTO-55, produced by ISHIHARA SANGYO KAISHA, LTD., and the like.

Further, employed as fine organic particles are fine spherical organic particles having a number average primary particle diameter of 10 to 2,000 nm. Employed as such particles may be homopolymers or copolymers of styrene or methyl methacrylate.

Lubricants may be incorporated in the toner to further improve cleaning property or transfer property. Listed as lubricants, for example, are metal salts of higher fatty acids, such as salts of stearic acid with zinc, aluminum, copper, magnesium, calcium, and the like; salts of oleic acid with zinc, manganese, iron, copper, magnesium, and the like; salts of palmitic acid with zinc, copper, magnesium, calcium, and the like; salts of linoleic acid with zinc, calcium, and the like; and salts of ricinoleic acid with zinc, calcium, and the like.

The added amount of these external agents is preferably 0.1 to 5 percent by weight with respect to the toner.

Various types of mixing devices known in the art, such as tubular mixers, Henschel mixers, Nauter mixers, V-type mixers, and the like may be employed for the addition of external additives.

### Particle Diameter of Toner Particles

It is preferable that toner particles composing a toner has a volume based median diameter (D50v) is not less than 3 μm and not more than 10 μm in the present invention. Toner having above mentioned volume based median diameter can reproduce very fine dot image of such as, 1,200 dpi (dpi: dot number in inch (2.54 cm)) with high fidelity.

The volume-based median diameter (volume D 50% diameter) can be measured and calculated using a Coulter Multisizer III (Beckmann Coulter Co.) which was connected to a computer system for data processing (Beckmann Coulter Co.).

To 20 ml of an aqueous surfactant solution (for example, a neutral detergent containing surfactant components is diluted to a factor of 10 with pure water) is added 0.02 g of a toner and dispersed with an ultrasonic homogenizer for 1 min. to prepare a toner dispersion. This toner dispersion is injected by a pipette into a beaker in which ISOTON II (Beckman Coulter Co.) within a sample stand has been placed until reaching a measurement concentration of 5% to 10%, and then, the measurement count is set to 2,500 and the measurement process is started. There is used 50 μm of the aperture diameter for the Coulter Multisizer III.

### Particle Size Distribution of Toner Particles

The variation coefficient (CV value) of particle size distribution on volume base is preferably from 8 to 21% and more preferably from 10 to 19%.

The variation coefficient of particle size distribution on volume base is calculated by the following expression.

Variation coefficient of particle size distribution on volume base (%)=(S₂/Dn)×100.

In the above, S₂ is the standard deviation of the particle size distribution on volume base and Dn is the median diameter D₅₀ on volume base.

When the CV value is smaller the, this means that the particle size distribution is sharper, and the size of the toner particles has good uniformity. When the CV value satisfies the above value range, it is possible to form an image of high quality level as an image prepared by a printing ink to reproduce fine dot image or fine line image with high precision required for digital type image forming method, since the particle size distribution has high uniformity.

### Softening Point Temperature of Toner

It is preferable that the toner of the present invention has a softening point (Tsp) of not less than 70° C., and not more than 110° C., and more preferably not less than 70° C., and not more than 100° C. The colorant incorporated in the toner of this invention has a stable property in which does not change reflection spectrum does not change when it is subjected to heat, and the affect by heat applied to the toner as well as the colorant is reduced, and consequently it is expected that an image having stable color reproduction property widely can be formed when the Tsp satisfies the above mentioned temperature range.

When the softening point toner satisfies the abovementioned temperature range toner image can be fixed by lower temperature than conventional fixing temperature, and power for fixing can be reduced and therefore, environmental load is also reduced.

The softening point temperature of the toner can be controlled by, for example, the following method singly or in combination with two or more

(1) Controlling species and content ratio of monomers for forming binder resin of the toner particles.
(2) Controlling molecular weight of the binder resin for forming the toner particles by adjusting species and amount of the chain transfer agent for forming the binder resin.
(3) Adjusting species and amount of wax and so on contained in the toner particles.

The softening point of the toner is measured in the following way.

The softening point of the toner is measured by the following method: The toner is formed into a cylinder shape having a height of 10 mm and set in a plunger of a measuring device, Flow Tester CFT-500 manufactured by Shimadzu Corp., and extruded through a nozzle having a diameter of 1 mm and a length of 1 mm while applying a load of 1.96×10⁶ Pa and heating at a temperature rising rate of 6° C./min. Then a plunger falling distance-temperature curve (softening flowing curve) is drawn and the softening point is determined by a temperature corresponding to a falling distance of 5 mm.

Further, said toner is blended with a carrier and employed as a two-component developer, or it is used as a non-magnetic a single-component developer.

A high speed a full color image can be formed by employing, for example, a tandem type image forming apparatus described later, when the toner of the present invention is used as a two-component developer.

In case that the toner is used as a two-component developer, employed as magnetic particles of the carrier may be conventional materials known in the art, such as metals such as iron, ferrite, magnetite, and the like, alloys of said metals with aluminum, lead and the like. Specifically, ferrite particles are preferred.

The volume average particle diameter of said magnetic particles is preferably 15 to 100 μm, and is more preferably 25 to 80 μm.

When the toner of the present invention is used as non-magnetic single-component developer without using a carrier in an image forming method, the toner is charged by sliding with pressure to a charging parts or a developing roller surface during image forming.

Structure of the developing unit in non-magnetic single-component development type image forming method can be made compact, and it is advantageous because image forming apparatus as a whole can be made compact. Therefore, the toner of the present invention is used as non-magnetic single-component developer, full color image forming by a compact image forming apparatus is realized and a full color image with excellent color reproduction property can be formed in an operation circumstance with limited space.

### Image Forming Method

An image of full color with high chroma can be formed by an image forming method of the present invention, in which full color toner kit composed of at least four species of color toners. Colored particles composing magenta toner particles for a magenta toner composing full color toner kit is manufactured by a specific process, and comprising the magenta colorant.

### Full Color Toner Kit

The full color toner kit includes at least four toners of a yellow toner for developing an electrostatic image (hereafter referred as “a yellow toner” in abbreviate), a magenta toner for developing an electrostatic image, a cyan toner for developing an electrostatic image a cyan toner (hereafter referred as “a cyan toner” in abbreviate) and a black toner for developing an electrostatic image (hereafter referred “a black toner” in abbreviate), each composed of toner particles containing at least a binder resin and a colorant.

### Yellow Colorant

The yellow colorant for a yellow toner includes, practically, a dye of C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, and C.I. Solvent Yellow 162, and a pigment of C.I Pigment Yellow 14, C.I Pigment Yellow 17, C.I Pigment Yellow 74, C.I Pigment Yellow 93, C.I Pigment Yellow 94, C.I Pigment Yellow 138, C.I Pigment Yellow 155, C.I Pigment Yellow 180, and C.I Pigment Yellow 185, as well as mixture thereof.

### Cyan Colorant

The cyan colorant for a cyan toner includes, practically, C.I. pigment blue 15, C.I. pigment blue 15;2, C.I. pigment blue 15;3, C.I. pigment blue 15;4, C.I. pigment blue 16, C.I. pigment blue 60, C.I. pigment blue 62 and C.I. pigment blue 66.

### Black Colorant

As the black colorant to be used in the toner of the invention, carbon black and magnetic substances can be optionally used. As the carbon black, channel black, furnace black, acetylene black, thermal black and lamp black are usable. The magnetic substance include a ferromagnetic metal such as iron, nickel and cobalt, alloys containing such the metal, compounds of ferromagnetic metal such as ferrite and magnetite, alloys which displays ferromagnetism by heating treatment though contains no ferromagnetic metal such as alloys of manganese-copper-aluminum and manganese-copper-tin so called as Heusler's alloy, and chromium dioxide.

It is preferable that the yellow colorant, cyan colorant and black colorant are dispersed with a number average primary particle diameter of about 10 to 200 nm in toner particles.

Content ratio of these colorants are preferably 1 to 10% by weight in each toner respectively, and more preferably 2 to 8% by weight to realize sufficient coloring power and good developability or chargeability.

### Magenta Colorant

The magenta colorant for a magenta toner comprises C.I. Solvent Red 48.

An image forming method is described in which a toner of the present invention is used as a two-component developer.

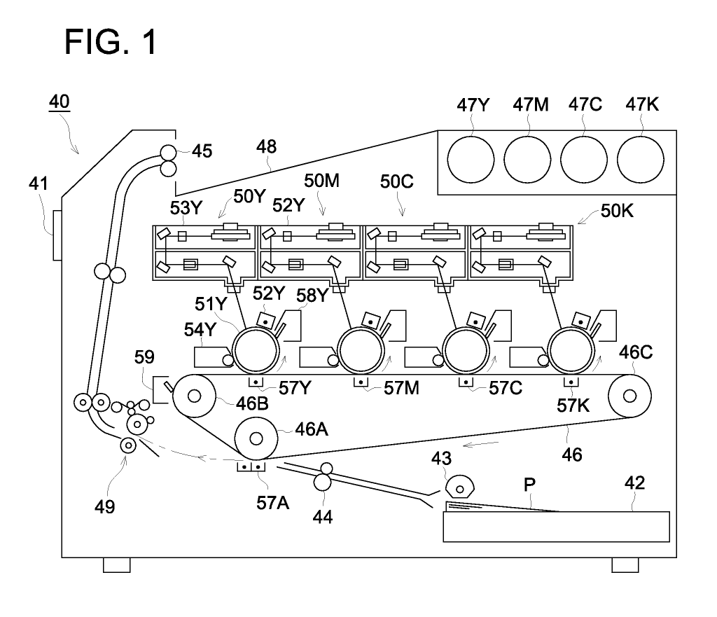

FIG. 1 is a schematic view showing an example of an image forming apparatus utilized in the present invention.

An image forming apparatus 40 is a tandem system full color image forming apparatus, structured in such a manner that plural groups of image forming units 50Y, 50M, 50C and 50K, are arranged along with a belt type intermediate transfer medium 46, a paper supplying cassette 42, as well as a fixing device 49. In FIG. 1 an operation panel 41, and toner cartridges 47Y, 47M, 47C, 47K are shown.

The image forming unit 50Y, forming yellow images, is provided with a photoreceptor 51Y, a charging member 52Y, an exposing member 53Y, a developing device 54Y, a first transfer device 57Y, and a cleaning device 58Y.

The image forming units 50M, 50C and 50K forms magenta, cyan, and black toner image respectively in place of yellow toner image, and the others are the same as the image forming unit 50Y.

A yellow toner image is formed by the image forming unit 50Y, the image forming unit 50M forms a toner image of magenta color, an image forming unit 50C forms a toner image of cyan color, and the image forming unit 50K forms a toner image of black color.

The intermediate transfer member 46 is winded on plural rollers 46A, 46B and 46C and circulatably supported.

Images of each color, formed in the image forming units 50Y, 50M, 50C, and 50K, are primarily transferred in sequence onto the rotating intermediate transfer medium 46 by the transfer members 57Y, 57M, 57C and 57K to form composite color images by superposing.

Paper sheets P stored in a paper feed cassette 42 are fed singly by a feed roller 43 and conveyed to a second transfer member 57A through a registration roller 44, whereby the color images are secondarily transferred onto each of the paper sheets P.

The paper sheet P, on which the color images have been transferred, is subjected to fixing by the fixing device 49. Then the paper sheet is clamped by a paper discharge roller 45, followed by being placed on a paper discharge tray 48 located outside the apparatus.

After the color toner image is transferred to image substrate P by second transfer member 57A, residual toner on intermediate transfer member 46 from which image substrate P is separated is moved by cleaning device 59.

The image forming method according to the present invention is not limited to the image forming method by the image forming apparatus described above, for example, the image can be formed by an image forming apparatus employing non-magnetic single-component developer.

According to the present invention, C.I. Solvent Red 48 is employed as a colorant contained in toner particles composing a toner for developing an electrostatic image. An image having bright color tone without color turbid and stable light fastness for long time can be formed by employing the toner for developing an electrostatic image, in which the colorant C.I. Solvent Red 48 is realized to be dispersed with high dispersion state in a binder resin of toner particles.

Further, an oil phase containing the colorant and a radical polymerizable monomer to form a binder resin is dispersed in aqueous medium, and the dispersion liquid is subjected to polymerizing process to form the colored particles, which compose the toner particles in an image forming method using a full color toner kit composed of at least four species of toners. In these circumstances, the magenta colorant composing the magenta toner particles comprises C.I. Solvent Red 48, therefore, an image of primary color formed by the magenta toner for developing an electrostatic image has bright color tone without color turbid, and further, the secondary color formed by superposing other color toners on the magenta toner has bright color tone and high chroma color image can be formed.

### EXAMPLE

The present invention is illustrated by practical examples.

### Magenta Toner Preparation Example 1, Toner Preparation by Suspension Polymerization

A mixture of 165 g of styrene, 35 g of n-butylacrylate, 15 g of C.I. Solvent Red 48, 2 g of di-t-butyl salicylic acid metal compound, 8 g of styrene-methacrylic acid copolymer, and 20 g of paraffin wax (melting point of 70° C.) was heated up to 60° C., was agitated via a sand grinder, and the colorant was dispersed. Ten grams of 2,2′-azobis(2,4-valeronitrile) as polymerization initiator was added and dissolved, whereby polymerizable monomer composition was prepared. Then, 450 g of 0.1M sodium phosphate aqueous solution was added to 710 g of ion-exchanged water, 0.5 g of 10% sodium dodecylbenzene sulfonate solution was further added, then 68 g of 0.1 M calcium chloride was added gradually while agitating via TK HOMOMIXER at 13,000 rpm, whereby suspension liquid in which tricalcium phosphate was dispersed was prepared. To the suspension liquid above described polymerizable monomer composition was added, was agitated via TK HOMOMIXER at 10,000 rpm for 20 minutes, whereby polymerizable monomer composition was dispersed so as to have a volume based median diameter of 6.1 μm. Then, it was subjected to reaction at 75° C. for 9 hours. Tricalcium phosphate was dissolved and removed by hydrochloric acid, and it was subjected to classification in liquid by centrifugal precipitation method employing a centrifugal separator, then the resultant was filtrated, rinsed and dried to obtain Colored Particles (1).

An external additive described below was added to 100 parts of the prepared Colored Particles (1) and external additive treatment was conducted via Henschel Mixer so that Magenta Toner (1) composed of Magenta Toner Particles (1) was prepared.

### External Additive

| | |
|---|---|
| Silica treated by hexamethyl silazane (number | 0.6 parts by weight |
| average primary particle diameter of 12 nm) | |
| Titanium dioxide treated by n-octyl silane (number | 0.8 parts by weight |
| average primary particle diameter of 24 nm) | |

External additive treatment via Henschel. Mixer was conducted in a condition of circumferential speed of agitation blade at 35 m/sec, processing temperature at 35° C., and processing time for 15.

### Magenta Toner Preparation Example 1, Toner Preparation by Emulsion Polymerization

### (1) Preparation of Resin Particles for Core Part (1)

Resin Particles for Core Part (1) having multiple layer structure was prepared by the first, second and third stage polymerization described below.

### (a) First Stage Polymerization

Placed in a vessel fitted with a stirrer, a temperature sensor, a cooling pipe, and a nitrogen introducing device was a surface active agent solution prepared by dissolving 20 parts by weight of the anionic surface active agent represented by following Formula (I) in 3,040 parts by weight of ion-exchanged water, and surfactant aqueous solution was prepared.

C₁₀H₂₁(OCH₂CH₂)₂SO₃Na Formula (1):

Into the surfactant aqueous solution 532 parts by weight of styrene, 200 parts by weight of n-butyl acrylate, 68 parts by weight of methacrylic acid, and a solution prepared by dispersing and dissolving 16.4 parts by weight of n-octylmercaptan, 80 parts by weight of C.I. Solvent Red 48, 5 parts by weight of 2-(2′-hydroxy-3′,′-di(1,1-dimethylbenzyl)phenyl)-2H-benzotriazole via SC mill were added, the resulted liquid was dispersed by employing “CLEARMIX W MOTION CLM-0.8” (product by M Technique Co.).

Into the surfactant aqueous solution, polymerization initiator solution prepared by dissolving 10 parts by weight of potassium persulfate (KPS) in 400 parts by weight of ion-exchanged water was added, temperature was increased to 75° C., then the first stage polymerization was conducted by heating and agitating at 75° C. for 2 hours, and Resin Particles (A1) containing colorant was prepared. The Resin Particles (A1) prepared in the first stage polymerization preparation had volume average molecular weight of 16,500, number average primary particle diameter of 195 nm.

### (b) Second Stage Polymerization

Monomer-mixture liquid composed of the following compounds was placed into a flask equipped with an agitation device, then, 93.8 parts by weight of paraffin wax HNP-57″ (product by Nippon Seiro Co., Ltd.) was added, and was dissolved by increasing the temperature up to 90° C. Thus monomer solution was prepared.

| | |
|---|---|
| Styrene | 101.1 parts by weight |
| n-Butyl acrylate | 62.2 parts by weight |
| Methacrylic acid | 12.3 parts by weight |
| n-Octylmercaptan | 1.75 parts by weight |

Surfactant aqueous solution was prepared by dissolving 3 parts by weight of above described anionic surfactant in ion-exchanged water of 1,560 parts by weight, temperature was raised to 98° C. Into the surfactant aqueous solution, 32.8 parts by weight (converted into solid substance) of Particles (A1) was added, and, monomer solution containing above described paraffin wax was added. The resulting material was dispersed by employing mechanical homogenizer “CLEARMIX” (produced by M Technique Co.) having a circulation channel for 8 hours. Emulsion particles dispersion liquid containing emulsion particles having dispersion particle diameter of 340 nm was prepared.

Then, polymerization initiator solution prepared by dissolving 6 parts by weight of potassium persulfate in 200 parts by weight of ion-exchanged water was added to above described emulsion particles dispersion liquid, Resin Particles (A2) was prepared by conducting polymerization (the second stage polymerization) in which the resulting material was subjected to agitation with heating at 98° C. for 12 hours. Volume average molecular weight of Resin Particles (A2) prepared by the second stage polymerization was 23,000, and number average primary particle diameter was 218 nm.

### (c) Third Stage Polymerization.

Polymerization initiator solution prepared by dissolving 5.45 parts by weight of potassium persulfate in 220 parts by weight of ion-exchanged water was added to Resin Particles (A2) obtained by the second stage polymerization, and monomer-mixture liquid composed of the following composition was dripped for 1 hour at 80° C. to it.

| | |
|---|---|
| Styrene | 293.8 parts by weight |
| n-Butyl acrylate | 154.1 parts by weight |
| n-octylmercaptan | 7.08 parts by weight |

After completion of addition, polymerization (the third stage polymerization) was conducted by agitation with heating for 2 hours. Resin Particles for Core Part (1) was prepared by cooling down to 28° C. after polymerization reaction. Resin Particles for Core Part (1) prepared by the third stage polymerization had volume average molecular weight of 26,800, and a number average primary particle diameter of 265 nm.

### (2) Preparation of Resin Particles for Shell (1)

Resin Particles for Shell (1) was prepared in the same manner as Resin Particles for Core Part (1) except that the monomer-mixture liquid used in the preparation of first stage polymerization was replaced by the following compounds, and polymerization reaction and treatment after reaction were conducted.

| | |
|---|---|
| Styrene | 624 parts by weight |
| 2-Ethylhexyl acrylate | 120 parts by weight |
| Methacrylic acid | 56 parts by weight |
| n-Octylmercaptan | 16.4 parts by weight |

### (3) Preparation of Magenta Toner (2)

### (a) Preparation of Core Part (1)

Into a reaction vessel equipped with agitation device, temperature sensor, a condenser tube, a nitrogen introducing device, 420.7 parts by weight of Resin Particles for Core Part (1) (converted to solid substance), 900 parts by weight of ion-exchanged water were introduced and were agitated. Temperature inside of the reaction vessel was adjusted at 30° C., and pH was controlled between 8 and 11 by adding 5 mol/L of aqueous solution of sodium hydroxide. Then, aqueous solution prepared by dissolving 2 parts by weight of magnesium chloride hexa hydrate in 1,000 parts by weight of ion-exchanged water was added thereto at 30° C. with agitation taking 10 minutes. Heating-up was started after 2 minutes standing, the temperature was raised up to 65° C. taking 60 minutes, whereby association of the particles was conducted. In this state, particle diameter of the association particles was measured by employing “MULTISIZER 3” (product by Beckman Coulter Inc.), when the volume based median diameter of the association particles reaches 5.5 μm, aqueous solution prepared by dissolving 40.2 parts by weight of sodium chloride in ion-exchanged water 1000 parts by weight was added to terminate the association. After termination of association fusion was continued by ripening treatment wherein agitation with heating was conducted at liquid temperature of 70° C. for 1 hour, thus Core Part (1) was prepared.

Average circularity of the Core Part (1) measured by “FPIA3000” (product by Sysmex Corp.) was 0.932.

### (b) Forming Shell Layer

The above obtained liquid was adjusted at 65° C., and 96 parts by weight of Resin Particles for Shell (1) was added thereto. Further, aqueous solution prepared by dissolving 2 parts by weight of magnesium chloride hexa hydrate in 1,000 parts by weight of ion-exchanged water was added taking 10 minutes, temperature was raised up to 70° C., and agitation was conducted for 1 hour. Thus, Resin Particles for Shell (1) was fused on the surface of the Core Part (1), shell was formed by conducting ripening treatment at 75° C. for 20 minutes. Shell forming was terminated by adding aqueous solution prepared by dissolving 40.2 parts by weight of sodium chloride in 1,000 parts by weight of ion-exchanged water. It was cooled to 30° C. at a rate of 8° C./minutes, produced colored particles were filtrated, rinsed with ion-exchanged water at 45° C. repeatedly, dried by warm air at 40° C. Thus Colored Particles (2) having shell layer on the surface of the core part was prepared.

Average circularity of the Colored Particles (2) measured by “FPIA3000” (product by Sysmex Corp.) was 0.965, and volume based median diameter was 5.9 μm.

### (c) External Additive Treatment

Magenta Toner (2) composed of Magenta Toner Particles (2) was prepared in which the following external additives was added to 100 parts of Colored Particles (2) thus prepared, and external additive treatment was conducted by employing Henschel Mixer.

| | |
|---|---|
| Silica treated by hexamethyl silazane (number | 0.6 parts by weight |
| average primary particle diameter of 12 nm) | |
| Titanium dioxide treated by n-octyl silane (number | 0.8 parts by weight |
| average primary particle diameter of 24 nm) | |

The external additive treatment employing Henschel Mixer was conducted in a condition of circumferential speed of the agitation blade at 35 m/sec, processing temperature at 35° C., processing time for 15.

### Comparative Magenta Toner Preparation Example 1

### Preparation of Toner by Kneading-Pulverization Method

The following compounds for toner were put into “Henschel Mixer” (product by Mitsui Mike Mining Co.) and were subjected to mixing treatment in a condition of circumferential speed of agitation blade at 25 m/sec for 5 minutes.

| | | |
|---|---|---|
| Polyester resin (bisphenol A ethyleneoxide | 100 | parts by weight |
| adduct, Condensation product of terephthalic acid | | |
| and trimellitic acid, volume average molecular | | |
| weight of 20,000) | | |
| C.I. Solvent Red 48 | 5 | parts by weight |
| Wax (pentaerythritol tetrastearate) | 6 | parts by weight |
| 2,4-dihydroxybenzophenone | 0.4 | parts by weight |
| Charge control Agent (boron dibenzilic acid) | 1 | part by weight |

The mixture of the above listed compounds were knead by a double spindle extrusion kneader, then, was roughly crushed by a hammer mill, the was pulverized by “TURBO MILL Pulverizer” (product by TURBO KOGYO CO., LTD.), further, was classified finely via an air stream classifier utilizing Coanda effect. Thus Comparative Colored Particles (1) having volume based median diameter of 5.5 μm was obtained.

The external additives described as follows were added to 100 parts of Comparative Colored Particles (1), via Henschel Mixer, and Comparative Magenta Toner (1) composed of Comparative Magenta Toner Particles (1) was prepared.

| | |
|---|---|
| Silica treated by hexamethyl silazane (number | 0.6 parts by weight |
| average primary particle diameter of 12 nm) | |
| Titanium dioxide treated by n-octyl silane (number | 0.8 parts by weight |
| average primary particle diameter of 24 nm) | |

The external additive treatment via Henschel Mixer was conducted in a condition of circumferential speed of agitation blade of 35 m/sec, processing temperature at 35° C., and processing time for 15.

### Comparative Magenta Toner Preparation Example 2

Comparative Magenta Toner (2) was prepared in the same manner as in the preparation process of Magenta Toner Preparation Example 1, except that “C.I. pigment red 122” was used in place of “C.I. Solvent Red 48”.

### Comparative Magenta Toner Preparation Example 3

Comparative Magenta Toner (3) was prepared in the same manner as in the preparation process of Magenta Toner Preparation Example 1, except that “C.I. Pigment Red 122” was used in place of “C.I. Solvent Red 48”.

### Yellow Toner Preparation Example 1

Yellow toner (1) was prepared in the same manner as in the preparation process of Magenta Toner Preparation Example 1, except that “C.I PIGMENT Yellow 74” was used in place of “C.I. Solvent Red 48”.

### Yellow Toner Preparation Example 2

Yellow toner (2) was prepared in the same manner as in the preparation process of Magenta Toner Preparation Example 2, except that “C.I PIGMENT Yellow 74” was used in place of “C.I. Solvent Red 48”.

### Cyan Toner Preparation Example 1

Cyan toner (1) was prepared in the same manner as in the preparation process of Magenta Toner Preparation Example 1, except that “C.I PIGMENT Blue 15:3” was used in place of “C.I. Solvent Red 48”.

### Cyan Toner Preparation Example 2

Cyan toner (2) was prepared in the same manner as in the preparation process of Magenta Toner Preparation Example 2, except that “C.I PIGMENT Blue 15:3” was used in place of “C.I. Solvent Red 48”.

### Black Toner Preparation Example 1

Black toner (1) was prepared in the same manner as in the preparation process of Magenta Toner Preparation Example 1, except that “Carbon Black Mogul L” was used in place of “C.I. Solvent Red 48”.

### Black Toner Preparation Example 2

Black toner (1) was prepared in the same manner as in the preparation process of Magenta Toner Preparation Example 2, except that “Carbon Black Mogul L” was used in place of “C.I. Solvent Red 48”.

### Preparation of Developers

Magenta Developers (1), (2), Comparative Magenta Developers (1) to (3), Yellow Developers (1), (2), Cyan Developers (1), (2), and Black Developers (1), (2) having a toner content of 6% were prepared by adding a ferrite carrier covered with methylmethacrylate and cyclohexylmethacrylate resin having volume average particle diameter of 50 μm to each of Magenta Toner (1), (2), Comparative Magenta Toner (1) to (3), Yellow Toner (1), (2), Cyan toner (1), (2) and Black Toner (1), (2).

### Examples 1, 2, and Comparative Examples 1 to 3

Developers in combination as shown in Table 1 were installed in “bizhub C451” (product by Konica Minolta Business Technologies, Inc.) corresponding to an image forming apparatus multi work color printer illustrated in FIG. 1 in a market and the following evaluation was conducted.

### Evaluation of Color Reproduction Area in Full Color Image)

Each of yellow monochrome (Y), magenta monochrome (M), cyan monochrome (C), red (R), blue (B) and green (G) solid image in an area of 2 cm×2 cm was formed in a circumstance at a temperature of 20° C., and humidity of 50% RH, exhibit color gamut in a*-b* coordinate, and the area was measured. Color reproduction area was evaluated taking the Y/M/C/R/B/G color gamut area of Comparative Examples 2 was set as 100. The result is summarized in Table 1.

### Evaluation of Light Fastness

Magenta image of 10 cm×10 cm was formed and was exposed to xenon lamp irradiation at 70,000 lux for 480 hours by employing “XENON WEATHER METER XL75” (product by Suga Test Instruments Co., Ltd.). Change of reflection density between before and after exposure in % was measured. The result is summarized in Table 1.

TABLE 1

| | | | | | Evaluation | |
|---|---|---|---|---|---|---|
| | | | | | Color | Density |
| | Developer combination | | | | Area | Change |
| | Magenta | Yellow | Cyan | Black | (*) | (%) (**) |
| Example 1 | Magenta 1 | Yellow 1 | Cyan 1 | Black 1 | 125 | 0.9 |
| Example 2 | Magenta 2 | Yellow 2 | Cyan 2 | Black 2 | 128 | 1.0 |
| Comp. | Comp. | Yellow 1 | Cyan 1 | Black 1 | 94 | 2.1 |
| Example 1 | Magenta 1 | | | | | |
| Comp. | Comp. | Yellow 1 | Cyan 1 | Black 1 | 100 | 8.7 |
| Example 2 | Magenta 2 | | | | | |
| Comp. | Comp. | Yellow 2 | Cyan 2 | Black 2 | 102 | 8.7 |
| Example 3 | Magenta 3 | | | | | |

(*) Color reproduction area
(**) Change of Reflective Density (%)

Examples according to the present invention give broader color reproduction area than the Comparative Examples, and are confirmed to form images having excellent light fastness.

1. A manufacturing method of a magenta toner for developing an electrostatic image, the magenta toner comprising colored particles containing at least a binder resin and a colorant, wherein the method comprises the steps of;
dispersing an oil phase containing a radical polymerizable monomer for forming the binder resin and the colorant in an aqueous medium to form dispersion liquid in which the oil phase is dispersed in a form of droplets in the aqueous medium, and
polymerizing the radical polymerizable monomer in the droplets in dispersion liquid to form resin particles containing colorant,
wherein the colorant comprises C.I. Solvent Red 48.

2. The manufacturing method of claim 1, wherein a volume based median diameter of the droplets is 50 to 500 nm.

3. The manufacturing method of claim 2, wherein a volume based median diameter of the resin particles is 50 to 500 nm.

4. The manufacturing method of claim 3, wherein the method further comprises the step of;
associating and fusing the resin particles containing colorant to form the colored particles.

5. The manufacturing method of claim 4, wherein a volume based median diameter of the colored particles is 3 to 10 μm.

6. The manufacturing method of claim 4, wherein the method further comprises the steps of;
separating the colored particles from the liquid, and rinsing and drying the separated colored particles.

7. The manufacturing method of claim 4, wherein the colored particles each has a core shell structure.

8. The manufacturing method of claim 7, wherein the core is composed of the resin particles manufactured by
dispersing an oil phase containing a radical polymerizable monomer for forming a binder resin and a colorant in an aqueous medium to form dispersion liquid in which the oil phase is dispersed in a form of droplets in the aqueous medium, the colorant comprises C.I. Solvent Red 48; and
polymerizing the radical polymerizable monomer in the droplets in dispersion liquid to form resin particles containing colorant and having a volume based median diameter of 50 to 500 nm.

9. The manufacturing method of claim 7, wherein the shell is composed of the resin particles manufactured by
dispersing an oil phase containing a radical polymerizable monomer for forming a binder resin and a colorant in an aqueous medium to form dispersion liquid in which the oil phase is dispersed in a form of droplets in the aqueous medium, the colorant comprises C.I. Solvent Red 48; and
polymerizing the radical polymerizable monomer in the droplets in dispersion liquid to form resin particles containing colorant and having a volume based median diameter of 50 to 500 nm.

10. The manufacturing method of claim 7, wherein a volume based median diameter of the colored particles is 3 to 10 μm.

11. The manufacturing method of claim 4, wherein the method further comprises steps of;
adding an external additive to the separated colored particles after drying.

12. The manufacturing method of claim 1, wherein a volume based median diameter of the droplets is 3 to 10 μm.

13. The manufacturing method of claim 12, wherein a volume based median diameter of the colored particles is 3 to 10 μm.

14. The manufacturing method of claim 13, wherein the method further comprises steps of;
separating the colored particles from the liquid, and rinsing and drying the separated colored particles.

15. The manufacturing method of claim 14, wherein the method further comprises steps of;
adding additives to the separated colored particles after drying.

16. The manufacturing method of claim 1, wherein the oil phase further contains a wax.

17. A magenta toner manufactured by the method of claim 1.

18. The magenta toner of claim 17 wherein the manufacturing method of the magenta toner further comprises the step of associating and fusing the resin particles containing colorant to form the colored particles, the oil phase further contains a wax, and the resin particles have a volume based median diameter of 50 to 500 nm.

19. The magenta toner of claim 17 wherein the droplets have a volume based median diameter of 3 to 10 μm, the colored particles have a volume based median diameter of 3 to 10 μm, and the oil phase further contains a wax.
